(19) United States
(12) Patent Application Publication
(10) Pub. No.: US 2008/0244746 A1
(43) Pub. Date: Oct. 2, 2008

(54) RUN-TIME REMEASUREMENT ON A TRUSTED PLATFORM

(76) Inventors: Carlos V. Rozas, Portland, OR (US); David Bowler, Beaverton, OR (US); Vincent R. Scarlata, Beaverton, OR (US); Burzin Daruwala, Aloha, OR (US)

Correspondence Address: INTEL CORPORATION;c/o INTELLEVATE, LLC, P.O. BOX 52050, MINNEAPOLIS, MN, 55402, US

(21) Appl. No.: 11/692,672

(22) Filed: Mar. 28, 2007

(51) Int. Cl. G06F 15/18

(52) U.S. Cl. 726/25

(57) ABSTRACT

A method and system are disclosed. In one embodiment, the method includes invoking a run-time measurement agent (RTMA) to run on a trusted platform, the RTMA measuring a core system code block multiple times after a single boot on the trusted platform; and a trusted platform module storing these multiple measurements.

### FIELD OF THE INVENTION

The invention relates to trusted platforms. More specifically, the invention relates to the measurement process on a trusted platform.

### BACKGROUND OF THE INVENTION

Computer security issues are becoming more widespread as an ever-increasing number of diverse computer applications are developed. Problems such as viruses, worms, rootkits, spyware, and theft are plaguing the population of computer users. Additionally, as the Internet connects more people to each other, it also is fueling security problems because confidential information is more easily compromised.

A number of technology companies are promoting and contributing to the Trusted Computing Group, which develops, defines, and promotes open standards for hardware-enabled trusted computing and security technologies. These technologies include hardware modules and software interfaces that aim to work across multiple platforms.

Trusted platforms have introduced a new capability that allows the platform, through a combination of hardware, firmware, and system architecture, to measure, record, and optionally, verify system software that is loaded on the platform. This type of capability is often referred to as measured/verified/secure boot and/or launch of the platform. This capability, in combination with a network that is able to restrict network access, can be used to control admission to a network based on the identity of the platform and the underlying software loaded onto the platform.

One shortcoming with today's trusted platform is that the measurement of the system software running on the platform is done only when the system software is loaded. Consequently, in a system that is compromised at run-time, the platform measurements will not reflect the software currently executing on the platform.

### BRIEF DESCRIPTION OF THE DRAWINGS

The present invention is illustrated by way of example and is not limited by the figures of the accompanying drawings, in which like references indicate similar elements, and in which:

FIG. 1 describes one embodiment of the process utilized to remeasure a trusted platform at run-time.

FIG. 2 is a flow diagram of one embodiment of a process to measure and remeasure a core system code block after a single boot.

FIG. 3 is a block diagram of a computer system which may be used with embodiments of the present invention.

### DETAILED DESCRIPTION OF THE INVENTION

Embodiments of a method and system for run-time remeasurement on a trusted platform are described. In the following description, numerous specific details are set forth. However, it is understood that embodiments may be practiced without these specific details. In other instances, well-known elements, specifications, and protocols have not been discussed in detail in order to avoid obscuring the present invention.

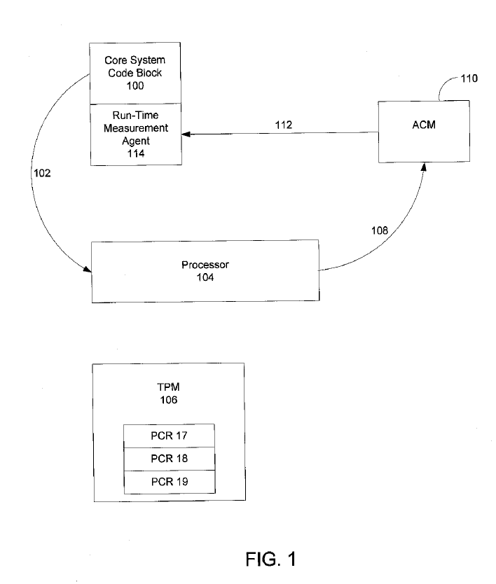

FIG. 1 describes one embodiment of the process utilized to remeasure a trusted platform at run-time. The measuring process, which is performed on a trusted platform, verifies which core system code block 100 is controlling the platform. In different embodiments, the core system code block 100 may be a virtual machine monitor (VMM), an operating system kernel, a reference monitor, or any other type of low level code that operates just above the hardware (i.e. the lowest level of a software stack).

To maintain as secure a platform as possible, it is imperative to assure that a non-compromised core system code block 100 is running on the platform. In some embodiments, the core system code block 100 is a VMM. In these embodiments, some of the VMM's duties include providing isolation among virtual machines and allowing information sharing among different virtual machines.

Remeasurement refers to the process of measuring the core system code block 100 a second, third, fourth, etc. time prior to a system discontinuity such as the machine being powered off or rebooted.

In many embodiments, some form of control code on the platform determines that the core system code block 100 needs to be measured. In other embodiments, the control code resides elsewhere on a network coupled to the trusted platform. The determination of the relative need for a measurement is somewhat dictated by the tasks running on the trusted platform as well as the length of time the platform has been operational sans measurement. The longer the core system code block 100 runs without being measured, the greater the potential for one or more breaches of security to happen. For example, if the platform has just booted, there will not have been a great deal of time or number of transactions dealing with the block for the core system code block 100 to be compromised. On the other hand, if the core system code block 100 has been running for 30 minutes there is greater potential for the security breach. Additionally, the type of transactions that the user of the platform is performing also will dictate the relative need for a measurement. If the user is playing a game, the need for a secure platform is somewhat low. Whereas, if the user is performing an online banking transaction, the need for a secure platform is quite high. Thus, a combination of the length of time since the last measurement as well as the type of work the platform is performing will determine the relative need for a measurement.

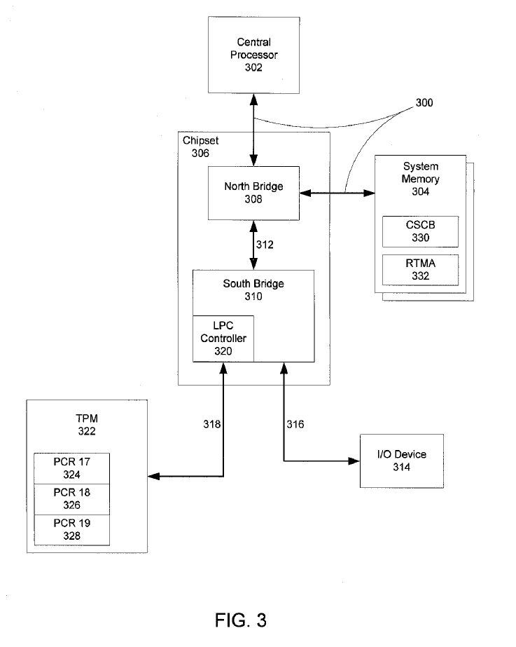

Once it has been determined to run a measurement, either by the user or some form of control code, the core system code block 100 sends out one or more instructions 102 to the controlling processor 104 on the platform to begin the process. In many embodiments, the controlling processor 104 is a general purpose processor utilized to execute code stored within system memory. A detailed embodiment of the components within the trusted platform is discussed in FIG. 3 below. The controlling processor 104 runs a series of operations to prepare the platform to measure the core system code block 100. In some embodiments, these series of operations are stored in microcode within the controlling processor 104. The controlling processor 104 first synchronizes any other processors on the platform if the platform contains multiple processors. All processors not performing the measurement enter into the same state and stop executing code. In many embodiments, a chipset residing on the platform helps coordinate the synchronization of processors and detects when additional processors are added to the system. In many embodiments, in addition to providing these functions, the chipset also provides general I/O capabilities, such as coupling one or more I/O devices through one or more interconnects. In many embodiments, one or more of the additional interconnects is a point-to-point interconnect. In many embodiments, the TPM can be located internally within the chipset. In many other embodiments, the TPM is a separate device coupled to the chipset by way of one of the additional interconnects. In many other embodiments, the TPM is located within on one of the additional I/O devices.

The controlling processor 104 then sends out a command to a Trusted Platform Module (TPM) 106 located on the platform to reset the relevant platform configuration registers (PCRS) that are stored within the TPM 108. In many embodiments, the relevant PCRs are PCR 17, 18, and 19 (discussed in detail below). The TPM is a hardware device designed to independently handle trust-based transactions on a given computer platform. In some embodiments, the TPM 106 is externally coupled to a chipset in the trusted platform by way of an interconnect. In other embodiments, the TPM 106 may be coupled to the chipset internally and located within the chipset. In yet other embodiments, the TPM 106 may be located within another external device, wherein the external device is coupled to the chipset.

Each TPM has a number of internal functions and hardware to execute them. A TPM may include an execution engine, program code, storage, registers, encryption algorithms and key generators among other items. Detailed information regarding the fundamentals of a TPM is readily available from the Trusted Computing Group organization. Their latest version of the TPM specification is Revision 94 from March 2006. Although the described embodiments below utilize a TPM to perform many crucial functions, in other embodiments, any other device or module which may provide similar properties and functionality to the TPM could be alternatively utilized.

Finally, after the relevant PCRs are reset, the controlling processor 104 executes one or more instructions 108 that enable to platform to load an authenticated code module (ACM) 110 into internal private, protected memory, authenticate the ACM 110, register the identity of the ACM 110 in a PCR within the TPM 106, and then invoke the ACM 110. In one embodiment, PCR 17 stores the ACM 110 registration information. In different embodiments, the information regarding the ACM 110 that is stored in PCR 17 is dependent upon the authentication information utilized. By invoking the ACM 110, the controlling processor 104 provides the ACM 110 with control of the platform.

The ACM 110 checks that there is no improperly configured hardware. If hardware is configured properly, the ACM 110 performs a series of processes 112 to invoke a Run-Time Management Agent (RTMA) 114. The ACM 110 enables memory protection for RTMA 114. In some embodiments, the RTMA 110 is a separate entity from the core system code block 100. In other embodiments, the RTMA 110 may be contained within the core system code block 100. The ACM 110 then measures the RTMA 114 to determine which version of the RTMA 114 is loaded. To maintain the security of the platform, because the RTMA 114 is the lowest software foundation of the platform, verification that the correct RTMA 114 will be invoked on the platform is imperative. In some embodiments, this verification is done by collaborating with a policy out of TPM 106 or checking a signature

The ACM 110 then registers the RTMA 114 in a PCR within the TPM 106. In one embodiment, PCR 18 stores the RTMA 114 registration information. Finally, the ACM 110 invokes the RTMA 114. In the event that the RTMA 114 is a separate entity from the core system code block 100, the RTMA 114 then begins the process to measure the core system code block 100. In a standard trusted platform environment, the ACM 110 directly measures and invokes the core system code block 100 because remeasurement isn't applicable. In many embodiments, the RTMA 114 is utilized for efficient remeasurement purposes.

Once the RTMA 114 is invoked, it protects a block of memory for the core system code block 100. Then the RTMA 114 measures the core system code block 100 to verify its integrity and authenticity. After measurement is complete, the RTMA 114 registers the newly measured core system code block 100 into a PCR within the TPM. In some embodiments, PCR 18 is extended to allow the RTMA 114 information and the core system code block 100 information to coexist in the single register.

In many embodiments, the information stored in PCR 17 and PCR 18 is static information. Thus, once the core system code block 100 has been measured for the first time after a platform boot, the information that is saved into PCR 17 and PCR 18 should not change for any additional remeasurement procedures prior to another boot.

In many embodiments, the RTMA 114 then stores additional information into PCR 19. A TPM TICK NONCE value (a unique random number obtained for a given particular platform boot) is obtained to verify the boot instantiation of the TPM. A TPM TICK COUNT value is obtained at or very near the time the newly measured core system code block 100 is invoked for use as a counter starting point for determining the freshness of the measurement of core system code block 100. The freshness of the measurement of core system code block 100 refers to how recently the block was measured, which may indicate how likely it is to still accurately represent the system code block 100 as it resides in memory.

Additionally, the information received from the measurement of the most recent core system code block 100 is obtained. In some embodiments, the TPM TICK NONCE, TPM TICK COUNT, and core system code block 100 measurement information is stored in PCR 19 by extending the PCR. Finally, the newly measured core system code block 100 is invoked. In some embodiments, the RTMA 114 passes a copy of the TPM TICK COUNT to logic located in the platform to continuously measure the freshness of the core system code block 100 measurement. In some embodiments, the RTMA 114 will store the TPM TICK COUNT into a register or memory location and the logic will retrieve the value from there. The logic retrieves the value of the TPM TICK COUNT as it was created at or near the time the core system code block 100 was measured. When the user, the TPM, or any other control code operating within the platform wants to determine how fresh the core system code block 100 is, the original TPM TICK COUNT stored in a PCR in the TPM is compared against the current TPM TICK COUNT stored in the TPM clock to get a relative time delta that can determine freshness. In some embodiments, the logic that retrieves the TPM TICK COUNTs is located within the core system code block 100, and requests that the TPM sign these values ensure they are not tampered with.

In other embodiments, the RTMA 114 passes a copy of the TPM TICK COUNT to another agent to use for monitoring the time delta. In other embodiments, the logic that increments count and compares the time delta may be located in the TPM, or somewhere else on the platform. In many embodiments, the time delta logic reports the freshness of the core system code block 100 measurement to interested devices or users to determine when a remeasurement should occur.

In many embodiments, a variant of the above process to measure the core system code block 100 by the RTMA 114 is repeated while the platform operates from the same boot (i.e. the same nonce). Once it has been determined that the core system code block 100 is not sufficiently fresh, a determination that varies widely depending on the tasks the platform is currently performing, the measurement process must begin again. As described above, each measurement process after the first measurement, and without a reboot, is referred to as remeasurement.

The remeasurement process repeats in substantially the same manner with a few exceptions. In many embodiments, during remeasurement, the values in PCR 17 and PCR 18 do not need to be updated. As described, these values are static. Though, in many embodiments, PCR 19 does need to be updated. PCR 19 is cleared and rewritten with a new value. The TPM TICK COUNT is a new value that represents the current relative time on the platform. Thus, the TPM TICK NONCE and the new value for the current TPM TICK COUNT must be extended into PCR 19. Lastly, the value obtained by measuring the current run-time state of the core system code block 100 will also be extended into PCR 19. In an alternative embodiment, the remeasurement process may reset and restore values in PCRs 17, 18, and 19 for each remeasurement.

In many embodiments, the RTMA 114 takes one or more actions in response to each remeasurement. If the remeasurement results in a different or unfavorable value, the RTMA 114 may halt the system. For example, if the remeasurement shows that a security breach occurred, the RTMA 114 may send an interrupt that will stop further execution on the system. In other embodiments, the RTMA 114 may contact an information technology (IT) server or system administrator if the remeasurement comes up with a different or unfavorable value.

In many embodiments, the RTMA 114 may send a TPM-signed copy of PCR 17-19, including measurements of the original TPM TICK NONCE and TPM TICK COUNT and measurements of the current TPM TICK NONCE and TPM TICK COUNT to a remote agent. Data may be requested from the remote agent, and the remote agent may require the current security state of the platform the RTMA 114 is running on. Thus, sending this data would allow the remote agent to calculate the freshness of the latest remeasurement. This would give the remote agent the opportunity to verify the integrity of the platform is intact and only trusted software is running on the platform prior to any information being sent to the platform.

In some embodiments, the TPM is capable of storing information related to multiple measurements within PCRs located in the TPM. In other embodiments, information related to multiple measurements is stored in other storage locations within the TPM. In yet other embodiments, information related to multiple measurements is stored external to the TPM. Again, though the described embodiments utilize a TPM to perform many crucial functions, in other embodiments, any other device or module which may provide similar properties and functionality to the TPM could be alternatively utilized.

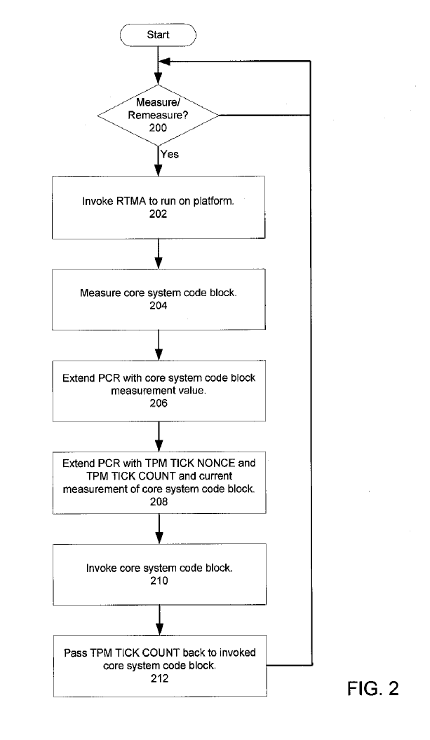

FIG. 2 is a flow diagram of one embodiment of a process to measure and remeasure a core system code block after a single boot. The process is performed by processing logic that may comprise hardware (circuitry, dedicated logic, etc.), software (such as is run on a general purpose computer system or a dedicated machine), or a combination of both. Referring to FIG. 2, the process begins by processing logic determining whether to measure/remeasure a core system code block (processing block 200). In some embodiments, the platform containing the core system code block is booting and the original measurement process would be invoked. In other embodiments, the platform has been operational for some time, it has been determined that the core system code block lacks freshness, and thus, the remeasurement process would be invoked.

Next, processing logic invokes an RTMA to run on the platform (processing block 202). The RTMA is given control of the platform and protects the core system code block in protected memory for measurement. Then processing logic measures the core system code block (processing block 204). The measurement process is described above in reference to FIG. 1.

Then processing logic stores the resulting measurement by extending a PCR within the TPM on the platform (processing block 206). Additionally, processing logic extends the PCR further with the TPM TICK NONCE value, TPM TICK COUNT values, and current measurement of the core system code block (processing block 208). The TPM TICK NONCE and TPM TICK COUNT values are utilized to determine the freshness of the most recent measurement of the core system code block.

Next, processing logic invokes (i.e. passes control of the platform) back to the measured core system code block (processing block 210). Finally, processing logic passes the TPM TICK COUNT back to the core system code block for future freshness determinations (processing block 212) and the process done. Though, this process may repeat at a future time.

FIG. 3 is a block diagram of a computer system which may be used with embodiments of the present invention. The computer system comprises a processor-memory interconnect 300 for communication between different agents coupled to interconnect 300, such as processors, bridges, memory devices, etc. Processor-memory interconnect 300 includes specific interconnect lines that send arbitration, address, data, and control information (not shown). In one embodiment, central processor 302 is coupled to processor-memory interconnect 300. In another embodiment, there are multiple central processors coupled to processor-memory interconnect (multiple processors are not shown in this figure).

Processor-memory interconnect 300 provides the central processor 302 and other devices access to the system memory 304. A system memory controller controls access to the system memory 304. In one embodiment, the system memory controller is located within the north bridge 308 of a chipset 306 that is coupled to processor-memory interconnect 300. In another embodiment, a system memory controller is located on the same chip as central processor 302 (not shown). Information, instructions, and other data may be stored in system memory 304 for use by central processor 302 as well as many other potential devices.

The chipset 306 also includes a south bridge 310 coupled to north bridge 308 through an interconnect 312. In some embodiments, interconnect 312 is a hub-link interconnect. I/O devices are coupled to the south bridge 310 of the chipset 306 through one or more I/O interconnects. For example I/O device 314 is coupled to the south bridge 310 through I/O interconnect 316. In many embodiments, one interconnect coupled to the south bridge 310 is Low Pin Count (LPC) interconnect 318. The LPC interconnect 318 has a host controller, LPC controller 320 in south bridge 310, to send information over the interconnect.

In many embodiments, TPM device 322 is coupled to LPC interconnect 318 to manage the trust of the computer system. In other embodiments, the TPM may be integrated into another controller that is connected transitively to the Central Processor 302. In some embodiments, the TPM may be integrated into chipset 306. In some embodiments, the TPM may be integrated into the north bridge 308 within the chipset 306. In other embodiments, the TPM may be integrated into a SuperIO chip coupled to the LPC interconnect 318. In yet other embodiments, the TPM may be integrated into a network interface card. All of these additional locations, apart from being coupled directly to the LPC interconnect, are not shown in the embodiment illustrated in FIG. 3. Though in different embodiments of the computer system, the TPM may be located in one of the additional locations described or yet another location within the computer system. TPM 322 includes internal storage to store important information. In many embodiments, this storage includes PCR 17, 18, and 19 (324, 326, and 328 respectively).

In many embodiments, and at different times, system memory stores a core system code block (CSCB) 330 as well as a Run-Time Management Agent (RTMA) 332. In many embodiments, the processor 302, TPM 322, and invoked RTMA 332 can be utilized to determine the freshness of the core system code block. Then if the block is not fresh, these components can be utilized to measure and then remeasure the core system code block 330 multiple times during operation of the trusted platform system after a single boot. The detailed procedure regarding the measurement and remeasurement process is discussed above in reference to FIG. 1.

Thus, embodiments of a method and system for run-time remeasurement on a trusted platform are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
invoking a run-time measurement agent (RTMA) to run on a trusted platform;
the RTMA measuring a core system code block a plurality of times after a single boot on the trusted platform; and
storing each of the plurality of measurements within a trusted platform module (TPM).

2. The method of claim 1, wherein the core system code block is one of a virtual machine monitor, an operating system kernel, and a reference monitor.

3. The method of claim 2, further comprising:
extending a platform configuration register (PCR) within a trusted platform module (TPM) located on the trusted platform to include a current TPM TICK NONCE value and a current TPM TICK COUNT value each time the core system code block is measured.

4. The method of claim 3, further comprising:
extending the PCR within the TPM to include one or more measurement values of the core system code block obtained from the RTMA measuring the core system code block.

5. The method of claim 3, further comprising:
the RTMA invoking the core system code block after each measurement; and the RTMA passing a copy of the current TPM TICK COUNT value to the invoked core system code block.

6. The method of claim 5, further comprising:
comparing the current TPM TICK COUNT value stored in the PCR with the continually incremented passed copy of the TPM TICK COUNT; and
determining the freshness of the previous core system code block measurement by utilizing the results of the comparison.

7. The method of claim 1, further comprising the RTMA:
protecting a block of memory on the trusted platform where the core system code block is loaded;
registering the core system code block; and
invoking the core system code block.

8. The method of claim 1, further comprising the RTMA performing one or more additional actions in response to the measurement of the core system code block.

9. A trusted platform system, comprising:
a first interconnect;
a processor coupled to the first interconnect;
a memory coupled to the first interconnect, the memory to store a run-time measurement agent (RTMA) and a core system code block, wherein the RTMA measures the core system code block a plurality of times after a single boot on the trusted platform;
a trusted platform module (TPM) coupled to the first interconnect, the TPM to locally store each of the plurality of measurements;
a second point to point interconnect; and
a chipset coupled to the first and second interconnects.

10. The system of claim 9, wherein the core system code block is one of a virtual machine monitor, an operating system kernel, and a reference monitor.

11. The system of claim 10, wherein the system:
extends a platform configuration register (PCR) within the TPM to include a current TPM TICK NONCE value and a current TPM TICK COUNT value each time the core system code block is measured.

12. The system of claim 11, wherein the system:
extends the PCR within the TPM located on the trusted platform to include one or more measurement values of the core system code block obtained from the RTMA measuring the core system code block.

13. The system of claim 11, further comprising:
the RTMA to invoke the core system code block after each measurement;
the RTMA to pass a copy of the current TPM TICK COUNT value to the invoked core system code block; and
the core system code block to continually increment the passed copy of the TPM TICK COUNT until the next measurement process of the core system code block is initiated.

14. The system of claim 13, wherein the system:
compares the current TPM TICK COUNT value stored in the PCR with the continually incremented passed copy of the TPM TICK COUNT; and
determines the freshness of the previous core system code block measurement by utilizing the results of the comparison.

15. The system of claim 9, further comprising the RTMA to:
protect a block of memory on the trusted platform where the core system code block is loaded;
register the core system code block; and invoke the core system code block.
